(19) United States
(12) Patent Application Publication
(10) Pub. No.: US 2011/0289008 A1
(43) Pub. Date: Nov. 24, 2011

(54) Use of Satellite-Based Geographical Positioning for Demarcating Real Estate Parcels Involved in Transactions

(76) Inventor: William LANDI, Devon, PA (US)

(21) Appl. No.: 12/781,905

(22) Filed: May 18, 2010

(51) Int. Cl. G06Q 50/00; G01S 19/51; G01C 21/00; G06Q 90/00

(52) U.S. Cl. 705/306; 705/500; 342/357.25; 342/357.34; 701/201

(57) ABSTRACT

The disclosure relates to a recording medium that includes both i) coordinates that are interoperable with a computerized satellite-based geographical positioning system and usable by that system to determine multiple geographical positions corresponding to a parcel of real estate and ii) other descriptive information corresponding to the parcel, such as photographs, written narrative descriptions, a property name or parcel number, or terms of a proposed transaction involving the parcel. Particular embodiments of the recording medium and uses therefor, such as in facilitating real estate transactions and communicating property descriptions are also disclosed.

### BACKGROUND OF THE DISCLOSURE

This disclosure relates generally to media and methods useful for describing and assessing real estate parcels, such as those offered for sale or lease in a commercial transaction.

For millennia, people have faced difficulties marking the boundaries of real estate parcels in ways that individuals unfamiliar with the boundaries can easily determine their location. Boundaries can be physically marked with physical objects (e.g., walls, signs, or a painted stripe), but many of these can be vandalized or moved and are difficult and expensive to install. Boundaries can also be described by reference to natural or artificial landmarks that occur in the vicinity of the boundary. However, such referential descriptions are susceptible to misunderstanding and differing interpretations.

Written descriptions of real estate parcels are among the earliest written records of mankind and are largely unchanged since before the beginning of recorded history. Written land records typically describe real estate parcels by reference to nearby natural or artificial landmarks, by reference to other real estate parcels, or by some combination of these. With the organization of human society into villages, towns, and cities, and together with adoption of names for streets, neighborhoods, and places therein, additional landmarks have been made that can be identified as points of reference in a written real estate description. Although such landmarks can be useful for describing the general relative location of a parcel, it can be difficult to describe the contours of parcel boundaries by references to nearby landmarks.

Development of postal and package delivery services have led to widespread adoption of numbered street and locale addresses that are useful for describing and finding the location of real estate parcels, but are generally not useful for describing the contours of parcel boundaries.

Highly accurate determination and recordation of boundaries can be achieved using modern surveying techniques. Such surveying techniques are frequently used in architectural and construction-related mapping of geographical features and in defining legal boundaries for real estate parcels. Although these surveying techniques yield property descriptions that are highly accurate, the vocabulary and parlance of geographical descriptions generated by surveying are dense, complicated, and beyond the understanding of most individuals not specially trained therein. As such, property descriptions prepared by surveyors have limited use to individuals seeking an easily-understood, accurate description of real property parcels.

Real estate transactions, including sales and leases of parcels and granting of rights to traverse or enter upon parcels, for example, are also among ancient human practices. In a real estate transaction, rights or relationships pertaining to a particular parcel of real estate (i.e., a property owned as a bloc, a portion of such as a property, or portions of multiple properties owned by different owners) are affected, with the intention that the effect should pertain to the particular parcel. When considering whether to enter such a transaction, a party often wishes to understand the location, size, shape, and contours of the parcel. Shortcomings in the ability to accurately convey this information can interfere with the ability or willingness of parties to a potential real estate transaction to consummate the transaction. This interference could be avoided if real estate parcel descriptions could be devised which convey this information in a clear and easily understood manner.

This disclosure describes such descriptions and methods of making and using them.

### BRIEF SUMMARY OF THE DISCLOSURE

Briefly summarized, this disclosure relates to use of multiple coordinates for a satellite-based geographical positioning system in combination with other description(s) of a real estate parcel to facilitate understanding of one or more of the location, size, shape, and contours of the parcel.

In one embodiment, a recording medium that includes both i) coordinates that can be input into a computerized satellite-based geographical positioning system and used by that system to determine multiple geographical positions corresponding to the parcel and ii) one or more descriptive attributes of the parcel, such as photographs, written narrative descriptions, a property name or parcel number, or terms of a proposed transaction involving the parcel. Information of both types can be included in the same or different formats. By way of example, both types of information can be included on a magnetic storage medium as magnetically encoded data. Further by way of example, these types of information can be recorded in different formats, such as on a paper medium having the coordinates recorded thereon in a format readable by a computerized optical-scanning device and descriptive information printed thereon as visually-readable text.

Also described herein are systems and devices for assessing real estate parcels. These include a recording medium that includes both codes operable with a computerized satellite-based geographical positioning system and one or more descriptive attributes of the parcel. The codes correspond to at least two (and preferably to several or many) geographical locations corresponding to the parcel (e.g., points along the perimeter of the parcel). Because the codes and descriptive attributes correspond to the same parcel, the device or system can be used to assess the parcel, since the user of the device or system is enabled to comprehend both geographical features of the parcel and other attributes of the parcel described by the medium. Thus, for instance, an offer to sell a parcel of real estate at a set price (i.e., a descriptive attribute of the parcel, to which might be added such information as photographs, zoning restrictions, the proposed sale price and terms, a narrative description of the parcel or buildings located thereon, and the like) can be stored using a storage medium that is also used to store Global-Positioning System (GPS) coordinates that correspond to the vertices of straight lines that define the boundary of the parcel. In such an instance, the device or system could be used to superimpose an image depicting the boundaries of the parcel on a GPS-calibrated map of an area that includes the parcel and to also display one or more descriptive attributes of the parcel. Such a device or system could also be used at the location of the parcel to indicate whether the device (i.e., which includes a GPS receiver in this example) is within, essentially on, or outside of a boundary of the parcel, while also being able to display one or more descriptive attributes of the parcel.

The recording media, devices, and systems described herein have a wide variety of uses in the field of being able to substantially simultaneously display descriptive attributes of a real estate parcel while providing codes that are operable with a computerized satellite-based geographical positioning system and that correspond to multiple geographical locations corresponding to the parcel. In one example, the technology is used to display one or more descriptive attributes of the parcel together with a cartographical representation of the location of the parcel. In another example, the technology is used in conjunction with a GPS receiver to display one or more descriptive attributes of the parcel while alerting the user as to whether the GPS receiver is within the boundaries of the parcel. In yet another example, the technology is used in conjunction with a GPS receiver and a vehicle-based navigational system to direct a user to one or more locations on, near, or within the parcel.

### DETAILED DESCRIPTION

The subject matter of this disclosure relates to satellite-based geographical positioning systems that have been developed by others, including the widely-used Global Positioning System (GPS) operated and maintained by the U.S. Air Force. The subject matter described herein relates to using satellite-based geographical positioning system data in combination with attributes of a real estate parcel (e.g., a parcel offered for sale) to facilitate transactions (e.g., inspections, sales, tours, and marking) involving the parcel. This object is achieved by making both the system coordinates and other recorded attributes of the parcel available to a person in combination, so that the two types of information can be used together by the person.

Satellite-Based Geographical Positioning System Coordinates

Satellite-based geographical positioning systems (SBGPSs) are well known, and include systems in which a system receiver receives controlled signals from multiple satellite transmitters. Using known methods, the signals received from the multiple transmitters are processed to determine a geographical location of the receiver, which is encoded as coordinates used by the system. In addition to describing the location of a receiver, coordinates of one of these systems can be used to uniquely identify any geographical position within the range of the multiple transmitters (or at least a minimum number of them, usually three or four), at least within the margin of error inherent in the signal transmission, measurement, and calculation limits of the system. The satellites used as transmitters can be geographically fixed, land-based transmitters (as in the LORAN system in the U.S., the OMEGA system operated by the U.S. Navy, or the CHAYKA system in Russia) or, preferably, earth-orbiting satellites, as in the Global Positioning System (GPS) operated by the U.S. Air Force. The precise operation of these systems is known and is beyond the scope of this disclosure. Although the GPS Precise Positioning Service can be used in the devices and methods described herein, that service is currently unavailable to civilian users, who instead have access to the slightly less precise GPS Standard Positioning Service, which can also be used as described herein.

In its current configuration, the GPS Standard Positioning Service provides geographical positioning accurate to within about 65 feet or less. A variety of known technologies and methods can be used to further refine the accuracy and precision of positioning that can be obtained using GPS and other SBGPSs, and those technologies and methods can be used in conjunction with the devices, systems, and methods described herein.

Coordinate systems useful in SBGPSs vary among the various systems, but are known in the art. As used herein, a “coordinate” is a set of information sufficient to uniquely identify a geographical location within a SBGPS system, regardless of the number of data required by the system to do so. The number of data used to uniquely identify a geographical position varies among SBGPS and the coordinate systems used to express locations.

Among the purposes for which SBGPSs have been used is navigation of vehicles, such as ships, aircraft, trucks, and automobiles. On a finer scale, SBGPSs have been used by others to guide agricultural machinery during, for example, planting of and application of pesticides to agricultural crops. SBGPSs are also used to record travel paths and to identify locations at which particular items (e.g., buildings) can be found. These uses demonstrate that SBGPSs can be used for the purposes described herein, namely for identifying real estate parcels and parts and boundaries thereof and for identifying whether one is within the boundaries of such a parcel or a selected portion thereof.

Descriptive Attributes of Real Estate Parcels

Substantially any information that is of interest to a person and that corresponds to a real estate parcel can be stored on the recording medium described herein as attributes of a real estate parcel. Non-limiting examples of such information includes descriptive data (e.g., narrative or bullet-list-type description of the parcel, sections thereof, or buildings thereon), taxation data (e.g., annual property taxes or tax rates, or historical tax payment amount and status information), agricultural production data (e.g., current or historical information describing production of animal or vegetable products), historical data (e.g., a narrative description regarding significant historical events that occurred on or involved one or more portions of the parcel), transactional data (e.g., records of previous sales, leases, easements, or other contractual relationships involving the parcel), ownership data (e.g., listings of current and/or past owners of the parcel and any information regarding past or present liens or other legal interests in the property), the street address of the parcel or one or more portions thereof, and zoning data (e.g., current or past zoning classifications or variances or proposed zoning changes involving the parcel).

Attributes that are of particular interest to parties and potential parties to real estate transactions include the nature of the transaction (e.g., whether the transaction is a sale, a lease, or a temporary or permanent easement) and the terms of the transaction (e.g., sale or leasing price, time periods during which the transaction is offered, names of other parties to the transactions and their representatives, and other conditions). In a preferred embodiment of the subject matter disclosed herein, SBGPS coordinates for a real estate parcel involved in a transaction or proposed transaction are operably associated with one another, so that a party or potential party to the transaction (or any other person assessing or observing the transaction) can simultaneously or nearly-simultaneously i) assess the terms of the transaction and ii) observe (directly or representationally, as with a cartographical representation) the geographical location of the parcel (and, optionally, one or more sub-parts of the parcel) through use of the SBGPS coordinates.

In one embodiment, the subject matter relates to a recording medium that is easily distributed to potential purchasers or lessors of a real estate parcel. The recording medium includes at least one, and preferably many, recorded attributes of the property, such as a description of the selling or leasing price of the property, a narrative (e.g., textual, audio, or video) description of one or more buildings that occurs on the property and the amenities of such buildings, zoning information regarding permissible uses of the parcel or subparts thereof, or information regarding routes for accessing various parts of the parcel. The recording medium also includes a plurality of SBGPS coordinates for the property, defining at least two geographical points corresponding to the property (e.g., opposite corners of a square-shaped parcel), and preferably more points (e.g., coordinates spaced approximately every 200 feet around the perimeter of a property or coordinates representing the vertices of a property having geometrically straight edges). The recording medium can, of course, include additional information (e.g., recorded images of the property at various seasons of the year). The recording medium can be given to a person as a component of a system that includes a receiver for the SBGPS system, a mechanism for retrieving and/or displaying the recorded attributes, an algorithm or system for displaying a cartographical representation of the parcel on a recognizable map (e.g., on a county or neighborhood street or property map), an algorithm or system for providing navigational directions for travel to the parcel, or some combination of these. By making these combined data available to a party or potential party to a real estate transaction in an operable (and especially if in an inter-operable format), the recording medium facilitates the transaction.

Although the subject matter described herein is particularly suited for use in facilitating real estate transactions, it can be employed in other settings. For example, relatively accurate (i.e., within ca. 65 feet) positioning of a person on a relatively large real estate parcel or among relatively widely-dispersed real estate parcels can be important for tourism and sight-seeing purposes. Such positioning can also be useful for guiding individuals among various events and displays at large fairs and festivals, such as state fairs and automobile festivals. In such settings, the recording medium can be used to store SBGPS coordinates corresponding to locations at which historical events occurred (e.g., troop positions and movements on a battlefield), landmark structures, and sites at which vendors or performances are located. The recording medium can also be used to store attributes corresponding to the sites for which SBGPS coordinates are recorded, such as the identity and achievements of troop formations on a battlefield, historical events corresponding to a landmark structure, hours of operation and merchandise descriptions for a vendor at a fair, and the show times and descriptions of performances at a festival. By associating these types of information in a single recording medium (or in a device that includes or is interoperable with the recording medium), individuals are enabled to appreciate the relationships between geographical locations (on a relatively precise level) and the attributes of those locations.

By way of specific example, Valley Forge National Historical Park near King of Prussia, Pa. is a U.S. national park that is approximately four square miles in size. The park has irregular boundaries, including numerous parcels of private property upon which park visitors are not welcome to travel. The park is located on the Winter 1777-1778 encampment site of the Continental Army during the American Revolutionary War. Within the park are numerous sites of historical interest including a house used as a headquarters by General George Washington, several areas in which the military units of the various American colonies are believed to have camped, an area believed to have served as a military cemetery during the encampment, a drill and parade ground, defensive fortifications, a visitor's center, and various memorials and statues. Owing to the passage of time and environmental erosion, many of these geographical features are not apparent to a casual viewer. Other of these features (e.g., monuments) are plainly visible, but difficult to locate within the broad area of the park. Coordinates for each of these features (e.g., individual coordinates for small features such as statues, and series of coordinates for features such as defensive fortification lines) can be recorded on the recording medium described herein, as can descriptive information pertaining to the features. The recording medium can be provided to park visitors either in the form of a device that includes the recording medium, a receiver for the SBGPS system corresponding to the coordinates used, a device or algorithm for providing navigational directions to a selectable feature, a device or algorithm for displaying attributes of a selectable feature, or some combination of these. Alternatively, the recording medium can be provided to a park visitor in the form of a printed recording medium that includes a textual version of the attributes and coordinates in a printed form that can either be read by (e.g., from an optically-scannable format) or input into (i.e., input from printed numerical coordinates) into a hand-held or vehicle-mounted GPS system owned or rented by the visitor.

The recording medium can, of course, include coordinates and attributes corresponding to multiple real estate parcels. By way of example, the recording medium can include corresponding coordinates and attributes for multiple properties offered for sale or lease (e.g., all properties offered for sale or lease in a selected geographical district, such as a state or county). Likewise, outside the context of real estate transactions, the recording medium can be used to guide persons (e.g., tourists) among multiple locations or parcels that are not necessarily part of the same real estate parcel. By way of example, commercial tours of Lancaster County, Pennsylvania frequently bring tourists to various towns, schools, markets, meetinghouses, and family farms within the county. The recording medium can include coordinates and attributes for such sites, and is conveniently associated with SBGPS receivers, algorithms, and equipment for providing navigational directions among these sites.

It is not material how the coordinate(s) that correspond to the parcel and are recorded on the recording medium are generated. They can be taken from an archive, derived by calculation from other known coordinates, or empirically determined (e.g., using a SBGPS receiver at the location of the parcel to determine coordinates of vertices of the parcel boundaries or of one or more locations of interest on the parcel, such as the location of a buried wellhead). One embodiment of the technology described herein is a system that includes the recording medium (or multiple recording media) described herein, a SBGPS receiver for determining the SBGPS coordinates of the receiver, and a link (e.g., a cable or a radio- or Internet-connection that facilitates transfer of coordinates from the receiver to the recording medium. In operation, the system can be used to record SBGPS coordinates at two or more locations on, in, near, or along a route leading to, a real estate parcel. Using the link, the coordinates can be transferred to the recording medium, to which one or more attributes of the parcel can also be transferred to generate the recording medium described elsewhere herein.

Recording Medium

This disclosure relates, in part, to a recording medium for facilitating a proposed real estate transaction for a real estate parcel. The medium has recorded thereon a plurality of coordinates that are interoperable with a computerized SBGPS. Each of these recorded coordinates corresponds to a geographical position of the parcel (i.e., at least two coordinates corresponding to the parcel are recorded; other coordinates not corresponding to the parcel can also be recorded thereon, such as coordinates corresponding to other parcels or coordinates corresponding to the location of an office of an agent involved in the transaction). The medium also has recorded thereon at least one attribute of the parcel.

The nature and identity of the recording medium is not critical, so long as it is able to serve its purposes of conveying the attribute(s) of the real estate parcel to the person using the recording medium and conveying the coordinates (directly or indirectly) to a SBGPS so that the person can associate the attribute with either the parcel itself (i.e., at the location of the parcel) or a cartographical or photographic representation of the parcel.

The recording medium can, for example, be a machine-readable medium, such as a computer memory chip (e.g., an EPROM, EEPROM, or other flash memory storage circuit, such as a commercial “flash drive” having at type-A USB connection), a magnetic storage medium (e.g., a computer diskette or a magnetic stripe printed or laminated on a substrate such as a paper or plastic card), or a printed sheet, such as a sheet of paper having information printed thereon (e.g., using a laser or inkjet printer) in a machine readable format (e.g., in the form of a one- or two-dimensional bar code or other optically-scannable format).

The recording medium can also be a non-machine-readable format, such as an ordinary sheet of paper having printed thereon the attribute (e.g., in the form of text, maps, photographs, or some combination thereof), so long as the coordinates are printed thereon in a format in which they can be manually entered into a SBGPS by a person reading the paper. By way of example, when in non-machine-readable format, coordinates for the SBGPS that correspond to a parcel should be recorded in the format used by that SBGPS, such as degrees north or south of the equator and degrees east or west of the prime meridian. Regardless of the format, where the format is not machine-readable, a user of the recording medium should be able, manually, using a computerized algorithm, or otherwise, to transfer the recorded coordinates to the SBGPS so that the location corresponding to the coordinates can be determined by the SBGPS.

The format in which the coordinates and attributes are recorded on the recording medium is not critical, so long as the coordinates can be input into a SBGPS (or an algorithm that interprets SBGPS coordinates, such as a cartographical mapping system or a navigational system that uses SBGPS coordinates) and so long as the attributes can be perceived by a user. These data can be recorded, for example, as a computer-readable file such as an audio file, an image file, a slide show file, a video file, and combinations of these.

System for Assessing Real Property

The recording medium can be interfaced (electronically, logically, or manually) with a computerized system for facilitating assessment of a real property. Such a system includes a data storage device that includes both a descriptive attribute of the real property and the coordinates for a SBGPS that correspond to the geographical location of the real property (e.g., the recording medium described herein, regardless of whether the coordinates and attributes are stored on a single recording medium or on different recording media that are part of the same system). The system also includes a computerized navigational system capable of i) detecting the present location of at least one of the data storage device and the navigational system by communicating with the SBGPS and ii) providing navigational directions from the present location of the system to the geographical location of the real property. Such a system is useful, for example, in directing a person in a vehicle having (hand-held or vehicle-mounted) SBGPS navigational equipment to the location of the real estate parcel.

In one embodiment of this system, the data storage device of the system (or at least one data storage device of the system) includes multiple recorded (e.g., audio) narrative descriptions of the property. These descriptions can be of varying lengths or the same duration. Many SBGPS navigational systems are able to both calculate navigational directions and anticipated duration of a journey to the destination. By having multiple recorded descriptions of the real property, the system can fill some or all of the duration of the journey with performance or display of one or more of the recorded descriptions. Upon determining the approximate duration of the journey to the property, the system can select one or more of the recorded descriptions for performance or display, preferably selecting a recorded description or plurality of recorded descriptions having a duration substantially equal (and preferably slightly shorter than) the anticipated duration of the journey. By way of example, information considered especially pertinent (e.g., by the recorder of the information) can be included in the briefest of the descriptions, so that this information can be presented during the shortest duration journeys.

In such a system, the recording medium described herein (including the coordinates and at least one attribute of a real estate parcel, whether stored on the same recording medium or separate media within the system) can be packaged in a housing that either includes or can be functionally linked with a receiver for the SBGPS. The housing can be in multiple parts, and the recording medium can be detachable therefrom (e.g., to permit use of the same system with different recording media, the different media corresponding to different real estate parcels). By way of example, the recording medium can be a flash drive having a male type-A USB adapter, and the housing can include a female USB port adapter to functionally link the recording medium with the receiver.

A user wishing to assess multiple real estate parcels can have the coordinates and attributes for each parcel on the same flash drive (i.e., if the system includes an algorithm or program for selecting among the various coordinate/attribute sets). Alternatively, each flash drive can include coordinates and attributes for only a single parcel, with the user inserting the drive corresponding to the desired parcel (e.g., having that parcel name written on a tag or label associated with the flash drive) in order to use the system to assess the desired parcel.

The data storage device used by the system can include memory assets that are connected logically (e.g., by electronic, optical, or radio transmission link to the Internet), but not physically, with the system. Thus, instead of storing the coordinates and attributes on or in the data storage device directly, the data storage device may include a code or other designation that corresponds to coordinates and/or attributes stored in a memory asset that is logically connected with the system.

The system may be provided to a user in modular parts, with only the parts required by an individual user supplied. By way of example, many commercially available GPS receivers and GPS navigational systems are capable of accepting data from external systems by way of a cable or other data link. So long as the user's components are operable with the supplied system components (e.g., using commercially available equipment, algorithms, or software), the system can be assembled using both the user's and the system provider's components.

In addition to the coordinates and attributes of the real property (or links or references to them), the system can include memory, recordable media, or circuitry encoding one or more of i) an algorithm for calculating a geographical position of a receiver for the positioning system; ii) an algorithm for determining proximity between the geographical positions of the parcel and a receiver for the positioning system; and iii) an algorithm for displaying the proximity of the receiver and the parcel on a display. The system can further include a SBGPS receiver and a display for providing navigational directions, one or more cartographical representations of the parcel and surrounding areas, the attributes (e.g., images of the parcel), and the like.

Methods

Included within this disclosure is a method for listing a real property offering. The method includes associating on a recording medium i) a coordinate that is interoperable with a computerized satellite-based geographical positioning system and that corresponds to the geographical location of the real property; and ii) a description of an attribute of the real property. The recording medium is distributed to a person having access to the positioning system so that that person can assess (and visit, if desired) the property. Relevant people to whom the recording medium might be distributed include a prospective purchaser of the real property, a representative of a prospective purchaser, or a real estate listing service (“person” being used in its corporate sense in this instance).

Also included within this disclosure is a method for assessing a real property. This method includes i) reviewing a descriptive attribute of the real property stored on a data storage device and ii) transferring coordinates for a satellite-based positioning system that correspond to the geographical location of the real property from the data storage device to a computerized navigational system. The computerized navigational system should be capable of a) detecting the present location of at least one of the data storage device and the navigational system by communicating with the positioning system and b) providing navigational directions from the present location to the real property. Using this method, a person interested in assessing the property can travel from his present location to the real property. As described herein, the person can review attributes of the property (e.g., recorded audio information that is encoded by the data storage device and that describes the real property) while travelling to the property.

The disclosure of every patent, patent application, and publication cited herein is hereby incorporated herein by reference in its entirety.

While the subject matter has been disclosed herein with reference to specific embodiments, it is apparent that other embodiments and variations of this subject matter can be devised by others skilled in the art without departing from the true spirit and scope of the subject matter. The appended claims include all such embodiments and equivalent variations.

1. A recording medium for facilitating a proposed real estate transaction for a parcel, the medium having recorded thereon
i) a plurality of coordinates that are interoperable with a computerized satellite-based geographical positioning system, each coordinate corresponding to a geographical position of the parcel and
ii) at least one attribute of the parcel.

2. The recording medium of claim 1, wherein the recording medium is machine-readable.

3. The recording medium of claim 1, wherein the recording medium is a printed sheet.

4. The recording medium of claim 3, wherein the coordinates are recorded in an optically-scannable form.

5. The recording medium of claim 1, wherein the recording medium is a magnetic recording medium and the coordinates are recorded as magnetically-readable data.

6. The recording medium of claim 1, wherein the recording medium is an optical recording medium and the coordinates are recorded as optically-readable data.

7. The recording medium of claim 1, wherein the attribute is selected from the group consisting of an image depicting a portion of the parcel, a narrative description of the parcel, taxation data, agricultural production data, historical data, transactional data, ownership data, zoning data, and combinations of these.

8. (canceled)

9. The recording medium of claim 1, including at least coordinates corresponding to each vertex defining the perimeter of the parcel.

10-13. (canceled)

14. The recording medium of claim 1, wherein the recording medium is packaged in a housing that can be functionally linked with a receiver for the system.

15. (canceled)

16. The recording medium of claim 1, wherein the attribute is recorded as text.

17-19. (canceled)

20. The recording medium of claim 1, also having recorded thereon an algorithm for receiving a positioning signal from the positioning system.

21. The recording medium of claim 20, also having recorded there on an algorithm for calculating a geographical position of a receiver of the positioning signal and an algorithm for determining proximity between the geographical positions of the parcel and the receiver.

22. A device comprising the recording medium of claim 21 and the receiver.

23-24. (canceled)

25. A method for listing a real property offering, the method comprising associating on a recording medium
a coordinate that is interoperable with a computerized satellite-based geographical positioning system and that corresponds to the geographical location of the real property; and
a description of an attribute of the real property and
distributing the recording medium to a person having access to the positioning system.

26. The method of claim 25, wherein the person is a prospective purchaser of the real property.

27. The method of claim 25, wherein the person is a representative of a prospective purchaser.

28. The method of claim 25, wherein the person is a real estate listing service.

29. The method of claim 25, wherein the associated coordinates and attribute are distributed in the form of a data storage device that encodes both the attribute and the coordinates.

30. The method of claim 29, wherein the data storage device is a sheet of paper having the coordinates and the attribute printed thereon.

31-37. (canceled)

38. A computerized system for facilitating assessment of a real property, the system comprising
a data storage device that includes both a descriptive attribute of the real property and the coordinates for a satellite-based positioning system that correspond to the geographical location of the real property, and
a computerized navigational system capable of
detecting the present location of at least one of the data storage device and the navigational system by communicating with the positioning system and
providing navigational directions from the present location to the geographical location of the real property.

39-75. (canceled)
